(19) United States
(12) Patent Application Publication
(10) Pub. No.: US 2023/0409874 A1
(43) Pub. Date: Dec. 21, 2023

(54) ACCELERATED TRANSFER LEARNING AS A SERVICE FOR NEURAL NETWORKS

(71) Applicant: Microsoft Technology Licensing, LLC, Redmond, WA (US)

(72) Inventors: Jorge Alexandre SILVA TAVARES, Munich (DE); Assaf AVIHOO, Herzliya (IL); Thilo WILL, Fresing (DE); Andrei Lucian AVRAM, Munich (DE)

(73) Assignee: Microsoft Technology Licensing, LLC, Redmond, WA (US)

(21) Appl. No.: 17/845,063

(22) Filed: Jun. 21, 2022

(51) Int. Cl. G06N 3/04; G06F 9/50

(52) U.S. Cl. CPC G06N 3/0454; G06F 9/5027

(57) ABSTRACT

Aspects of the present disclosure provide accelerated transfer learning for machine learning models, such as neural networks, as a service. In doing so, the aspects disclosed herein decouple the conversion process for use of machine learning models from deployment of the models in a production environment through the creation of one or more common generic models that execute on a hardware accelerator, such as a FPGA. Additional aspects of the disclosure relate to the creation of an accelerated machine learning model. The accelerated machine learning model is created by identifying common portions of a machine learning model that can be leveraged by a plurality of different machine learning models. Still further aspects of the disclosure relate to training scenario specific machine learning models for use with an accelerated machine learning model.

### BACKGROUND

The trend of using machine learning continues to accelerate as machine learning solutions are developed and applied to different problems and tasks across a myriad of industries. As part of this trend, many developers are moving towards leveraging deep neural architectures to perform tasks. However, the computational costs to train machine learning models and also to perform online tasks using the models may be prohibitive based upon the type of resources (e.g., hardware, compute power, etc.) required to do so.

It is with respect to these and other general considerations that the aspects disclosed herein have been made. In addition, although relatively specific problems may be discussed, it should be understood that the examples should not be limited to solving the specific problems identified in the background or elsewhere in this disclosure.

### SUMMARY

Aspects of the present disclosure provide accelerated transfer learning for machine learning models, such as neural networks, as a service. In aspects, an accelerated machine learning model is leveraged. The accelerated machine learning model comprises portions that are common to a plurality of different machine learning models. These portions are identified and compiled to be executed on a hardware accelerator. The output of the accelerated machine learning model is provided to a scenario specific machine learning model. The scenario specific model may be used to determine a specific task or make a specific determination. By leveraging the accelerated machine learning model to analyze input data, lightweight scenario specific machine learning models may be developed that can be executed on generic hardware, such as a central processing unit, while still meeting operational constraints defined by the task to be performed.

Additional aspects of the disclosure relate to the creation of an accelerated machine learning model. A machine learning model to be ported to a hardware accelerator is received. The machine learning model is analyzed to determine portions of the model that can be ported to the hardware accelerator. The identified portions of the machine learning model are compiled for execution on the hardware accelerator.

Still further aspects of the present disclosure relate to training a scenario specific machine learning model for use with an accelerated machine learning model. In one aspect, the scenario specific machine learning model may be trained based upon a set of training data. The portions of the scenario specific machine learning model that are common to the accelerated model are locked for training purposes. Alternatively, the scenario specific machine learning model may be trained based upon data generated by the accelerated machine learning model.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for providing an accelerated transfer learning service for machine learning models.

FIG. 2 illustrates an exemplary architecture for employing accelerated models in accordance with aspects disclosed herein.

FIG. 3 depicts an exemplary method for generating an accelerated model for use on a particular type of hardware accelerator

FIG. 4 depicts and exemplary method 300 for utilizing a combination of accelerator models and scenario specific models to perform a task.

FIG. 5A depicts an exemplary method for training a scenario specific model for use with the aspects disclosed herein.

FIG. 5B depicts yet another exemplary method for raining a scenario specific model for use with the aspects disclosed herein.

FIG. 6 is a block diagram illustrating example physical components of a computing device with which aspects of the disclosure may be practiced.

FIG. 7A is a simplified diagram of a mobile computing device with which aspects of the present disclosure may be practiced.

FIG. 7B is another simplified block diagram of a mobile computing device with which aspects of the present disclosure may be practiced.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

The trend of using machine learning continues to accelerate as machine learning solutions are developed and applied to different problems and tasks across a myriad of industries. As part of this trend, many developers are moving towards leveraging deep neural architectures to perform tasks. However, the computational costs to train machine learning models and also to perform online tasks using the models are much larger than previous approaches based on, for example, the size of models that are required to perform specific tasks. Online performance based on generic hardware (e.g., a central processing unit (CPU)) tends not to be viable for even small neural network models (e.g., small Neural Language Representations (NLRs)). Because of this, specialized hardware is leveraged, such as a graphics processing unit (GPU), to reduce latency when processing data using large machine learning models. However, it may be hard for some users to leverage GPUs due to the cost and supply constraints. Even large companies may find that their existing fleet of GPUs is only sufficient to handle tasks on limited basis. As such, to be able to reliably utilize large machine learning models in a production environment, other types of acceleration hardware may be leveraged. Example types of hardware accelerators include a field-programmable gate array (FPGA), a graphics processing unit (GPU), a tensor processing unit (TPU), an application-specific integrated circuit (ASIC)ASIC, or the like. In examples, acceleration hardware does not include standard processors, such as a CPU. For ease of description, aspects of the present disclosure are described with respect to use of an FPGA as a hardware accelerator. However, one of skill in the art will appreciate that the aspects disclosed herein may be employed to increase performance when leveraging large machine learning models using any type of hardware acceleration component, including GPUs, TPUs, ASICs, and the like.

Leveraging different types of hardware accelerators introduces difficulties based upon differences in their individual architectures. For example, leveraging an FPGA to process a machine learning model is not as straightforward as leveraging a CPU or GPU. Besides the standard issues of converting a machine learning model to an FPGA, e.g., architecture support, quantization impact, additional constraints are introduced based upon the platform itself. For example, the server configuration of hardware accelerators can be done in a way that only a small number of machine learning models can be deployed. However, once a machine learning model is configured for execution on an FPGA, FPGAs are capable of executing a machine learning model more efficiently than a standard CPU. Thus, an FPGA can be employed to execute machine learning models in situations where low latency determinations are required. As such, an FPGA provides a viable alternative for performing machine learning tasks when GPUs or other types of hardware accelerators are limited in availability due to system hardware restrictions.

Aspects of the present disclosure provide accelerated transfer learning for machine learning models, such as neural networks, as a service. In doing so, the aspects disclosed herein decouple the conversion process for use of machine learning models from deployment of the models in a production environment through the creation of one or more common generic models that execute on a hardware accelerator, such as a FPGA. In an example, a common generic model comprises a portion of a machine learning model that is common to a plurality of scenario specific machine learning models. That is, a common generic model comprises parts of a machine learning model that is usable across different specific machine learning models. In exemplary aspects, the common generic model is a large machine learning model, thereby allowing for the creation and use of smaller, scenario specific machine learning models. In an example, a scenario specific machine learning model is a machine learning model that is trained to perform specific tasks, such as, for example, a natural language processing model, a model trained to generate to-do lists and identify tasks from emails, a model trained to recognize specific objects in images or videos, or the like. One of skill in the art will appreciate that the aspects disclosed herein are applicable to any type of machine learning models trained to perform any type of different tasks or process any type of data.

In examples, input is provided to a common generic model. The input is processed using the common generic model to derive a set of one or more feature vectors. In order to increase performance, e.g., reduce latency or increase computational efficiency, the common generic model is executed using a hardware accelerator, such as an FPGA, a GPU, a TPU, or the like. The derived set of feature vectors is then provided as input to a scenario specific machine learning model, which processes the set of feature vectors to perform a specific task or determine a specific outcome. In doing so, the common generic feature model acts a featurizer for the scenario specific models. In aspects, a large portion of a machine learning model's architecture can include in the common generic model. As such, the scenario specific model may be reduced in size such that the scenario specific model can be executed using standard hardware, such as a CPU, in an efficient manner.

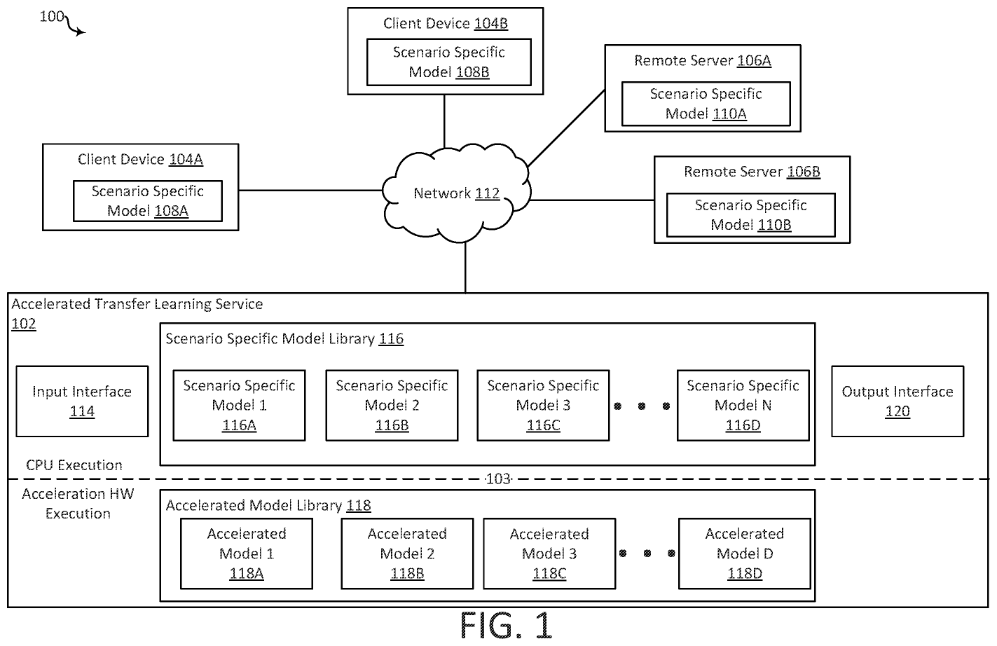

FIG. 1 depicts an exemplary system 100 for providing an accelerated transfer learning service for machine learning models. As shown in FIG. 1, an accelerated transfer learning service 102 communicates with a number of client devices (e.g., client device 104A and client device 104B) and/or remote servers (e.g., remote server 106A and 106B), via a network 112. Network 112 may be any type of network, such as a local area network (LAN), wide area network (WAN), a cellular data network, or the Internet. While a specific number of client devices 104A and 104B and remote servers 106A and 106B are depicted as part of system 100, one of skill in the art will appreciate that system 100 may include any number of client and/or remote devices. Further, while a single accelerated transfer learning service 102 is depicted as part of system 100, additional accelerated transfer learning services can be provided without departing from the scope of this disclosure.

Accelerated transfer learning service 102 may be a single device or a distributed network of devices (e.g., a cloud service). As shown in FIG. 1, the accelerated transfer learning service 102 includes an input interface 114, a scenario specific machine learning model library 116 (which stores a plurality of scenario specific models, such as scenario specific models 116A, 116B, 116C, and 116D), an accelerated machine learning model library 118, and an output interface 120. As shown in FIG. 1, line 103 indicates a distinction between the type of hardware used to execute the different components of the accelerated transfer learning service 102. The components above line 103 (e.g., input interface 114, scenario specific machine learning model library 116 and the stored scenario specific models 116A, 116B, 116C, and 116D), and output interface 120 are executed using standard hardware components (e.g., a CPU). The components below line 103 are executed using acceleration hardware (e.g., accelerated model library 118 and the stores accelerated models). In alternate aspects, the accelerated transfer learning service 102 may not include a scenario specific machine learning model library 116. Rather, individual scenario specific machine learning models may be executed on the various client devices (e.g., scenario specific model 108A on client device 104A, scenario specific model 108B on client device 104B, scenario specific model 110A on remote server 106A, and/or scenario specific model 110B on remote server 106B). In still further aspects, the scenario specific models may be stored and/or executed on both the accelerated transfer learning service 102 and one or more client or remote servers.

The accelerated model library 118 includes one or more accelerated models (e.g., accelerated model 1 118A, accelerated model 2 118B, accelerated model 3 118C, and accelerated model N 118D). The accelerated models are common generic models which comprise common parts of various machine learning models that are generated to execute on a hardware accelerator, such as an FPGA. Given the different architectural requirements required for models to work on different hardware accelerators, it may be difficult to port the machine learning models to work on the different architectures. However, use of a generic common model provides multiple benefits in light of these difficulties. First, using a common model for a specific hardware accelerator allows for the use of the mode with different scenario specific models without having to port each task specific model to the hardware accelerator. For example, when the hardware accelerator is an FPGA, model owners can design and train their scenario specific models using quantized embeddings. Second, the common model allows for efficient usage of available hardware platforms. For example, unnecessary hardware accelerators are not allocated, and additional traffic can be served, using the systems available hardware accelerators. As such, a larger number of scenario specific models can be placed into production. Third, it reduces the number of unique hardware accelerators required since only a base common model needs to be used for multiple scenario specific models. While specific benefits have been detailed herein, one of skill in the art will appreciate that other benefits are provided by the disclosed aspects.

In one example scenario, the accelerated transfer learning service 102 is operable to receive input from a device, such as client device 104, via the input interface 114. The input interface is operable to establish communications with a device, such as client device 104A, and receive data to be processed by the transfer learning service. The data received by the input interface 114 may include an indicator a specific task to be performed and/or a type of machine learning model to be used. The indicator may be used to select a scenario specific model from the scenario specific model library 116 and/or an accelerated model from the accelerated model library 118. In one example, the client or remote device requesting utilizing the accelerated transfer learning service 102 may opt to use a scenario specific model provided by the service. In such examples, the input interface 114 may receive the data to be processed by the accelerated transfer learning service 102 along with an indicator or a request for the accelerated transfer learning service 102 to perform a specific task or operate using a specific scenario. In said example, the accelerated transfer learning service 102 may be operable to identify the correct scenario specific model from the scenario specific model library based upon the task or scenario. The type of accelerated model selected from the accelerated model library may then be selected based upon the selected scenario specific model. That is, the scenario specific models may be associated with a specific accelerated model. In another example, requesting device (e.g., a client device or remote server) may utilize their own scenario specific model. In said examples, only an accelerated model may be selected from the accelerated model library based upon the task or scenario to be performed by the requestor's scenario specific model, based upon the type of machine learning model required, or both.

The data may be received in a raw form or as a vectorized data set. If the data is received in a raw form (e.g., a group of images to be processed, a set of emails, etc.) the raw data may be processed to generate a feature vector prior to being processed by an accelerated model. The vectorization may be performed by the input interface 114 or by the accelerated model selected from accelerated model library 118 (e.g., accelerated model 2 118B). The selected accelerated model receives the vectorized data set, or, alternatively, the raw data and generates feature vectors of the raw data, and processes the raw data using hardware accelerator, such as an FPGA, GPU, TPU, ASIC, etc. As discussed, the accelerated model is generated in accordance with the hardware accelerator capabilities that will ultimately execute the accelerated model. Further, as noted, the accelerated models may include a common, reusable part of one or more specific models. For example, the common parts of a transformer-based natural language processing model may be ported to a specific hardware accelerator to generate an accelerated model. These common parts may be used by any specific models (e.g., models trained to recognize a specific language, vocabulary, perform a specific task, etc.) may then leverage the generated accelerator model. In doing so, the specific models can be reduced in size and complexity, thereby allowing the specific models to be efficiently executed (e.g., executed with reasonable latency) using traditional hardware not optimized to execute machine learning models (e.g., a CPU). Upon receiving the vectorized data, the accelerated model (e.g., continuing with the above example, accelerated model 2 118B) processes the vectorized data to produce a transformed set of vectorized (or otherwise featurized) data. The transformed set is then provided to a scenario specific model.

In one example, the scenario specific model may be a scenario specific model that is part of the accelerated transfer learning service 102. For example, the transformed set generated by accelerated model 2 118B may be provided to scenario specific model 3 116C. The scenario specific model may be selected based upon the specific task or determination requested by the requesting party, e.g., a client device. The determination may be made based upon an indicator in the received request that identifies the required scenario specific model, by a task associated with the request, or by a link between the accelerated model and the scenario specific model. The scenario specific model, e.g., scenario specific model 3 116C in the described example, receives the transformed data set as an input and processes the transformed data set to generate an output. The output generated by the scenario specific model is in accordance with the specific task or determination that the scenario specific model was trained to produce. For example, a scenario specific model trained to generate a task list based upon user emails may generate a list of tasks as an output, a scenario specific model trained to identify objects in an image or video may generate a list of identified objects as output, provide a recommendation based upon the transformed data set, etc. In instances where a scenario specific model that is part of the accelerated transfer learning service 102 is used, the output generated by the scenario specific model may be provided to output interface 120. Output interface 102 may package and communicate the output to the requesting device, e.g., a client device or remote server device. In some examples, benefits may be derived from collocating the scenario specific model and the accelerated model, such as requiring less bandwidth to facilitate communications between the different types of models, reduced processing latency, etc.

However, the aspects disclosed herein do not require colocation of the scenario specific and task specific models. For example, a scenario specific model may be executed locally on a requesting client device (e.g., scenario specific model 108A of client device 104A) or requesting remote device (e.g., scenario specific model 110B of remote server 106B). In such instances, execution of the scenario specific model on the requesting device may be beneficial for privacy reasons (e.g., the requesting device may maintain privacy information locally) or for customization purposes (e.g., the requestor can generate a customized model to suit specific requirements rather than relying upon a more “generic” scenario specific model hosted by the accelerated transfer service 102. As used herein, a “generic” scenario specific model may refer to a scenario specific model that is intended to be used by multiple clients to perform a specific task, and, as such, is not specific to the particular needs of a client. In such instances, the transformed data set generated by an accelerated model may be provided to the output interface. The output interface packages and transmits the transformed data set to a requesting device (e.g., client device 104A). The requesting device receives the transformed data set and provides the transformed data set to a local scenario specific model, e.g., scenario specific model 108A in the described example, for further processing. The local scenario specific model then generates output based upon the local scenario specific model's training.

While specific examples of processing flows have been provided with respect to the discussion of system 100, one of skill in the art will appreciate that these are provided as examples only and do not limit the scope of this disclosure. As such, any specific discussions of requesting devices or use of identified scenario specific and accelerated models are provided for purposes of description only and other combinations of requestor devices, scenario specific models, and/or accelerated models may be employed without departing from the scope of this disclosure.

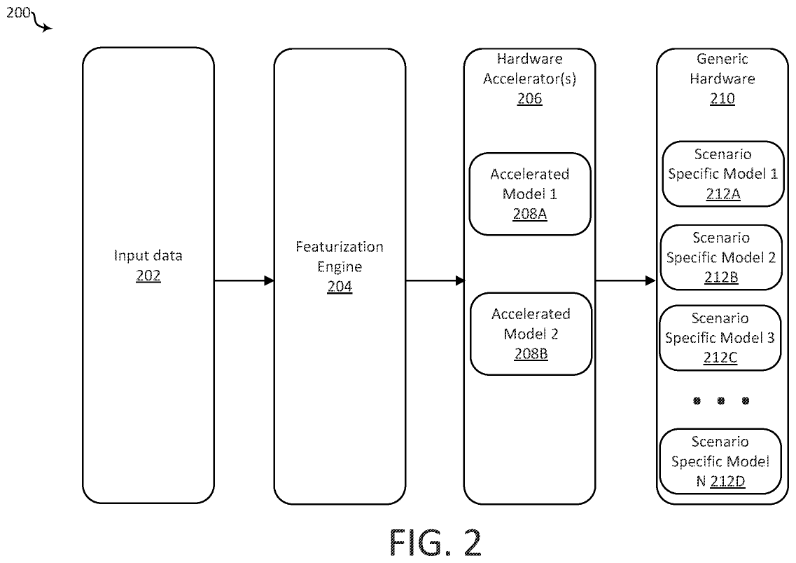

FIG. 2 depicts an exemplary architecture 200 for employing accelerated models in accordance with aspects disclosed herein. As shown in architecture 200, input data 202 is received. The input data corresponds to any type of data that may be processed using a machine learning model. For example, input data may be natural language input (e.g., audio data for speech, text-based data such as emails, transcripts, or the like), video data, image data, or any other type of data. One of skill in the art will appreciate that the aspects disclosed herein can be practiced with any type of machine learning model trained to perform any type of tasks or make any type of determination. As such, the input data 202 may be any type of data corresponding to the task or determination to be performed. Various different types of processes or components may be utilized to access or receive the input data 202. In examples, the input data may be associated with an identifier for a specific acceleration model and/or scenario specific model to be used. Alternatively, the input data may be associated with a task to be performed. The task may be used to determine the proper accelerated model and/or scenario specific model to be used.

Upon accessing or receiving the input data 202, the architecture 202 provides a featurization engine 204 to featurize the input data 202 for processing by the machine learning models. In one example, featurization engine may generate a set of feature vectors using the input data 202. The set of feature vectors is provided to the accelerated models for processing. As the aspects disclosed herein are operable to employ any type of machine learning model, any type of featurization known to the art may be employed without departing from the scope of this disclosure. Further, while architecture 200 depicts a standalone featurization engine, the featurization of the input data may be performed by the model itself, or by the component receiving the input data 202, without departing from the scope of this disclosure.

The featurized data (e.g., a set of feature vectors) may then be processed using a pretrained accelerator model. The pretrained accelerator model may be a model that is generated to be executed on a specific type of hardware accelerator (e.g., a FPGA, GPU, TPU, ASIC, etc.). As described above, the accelerator model represents a common model, that includes the common portions of a neural network. For example, different machine learning models may use a transformer-based natural language processing architecture to perform different tasks. A common model, as used herein, may be the portions of the transformer-based natural language processing architecture that will be similar across the different models regardless of the specific task being performed. As such, the similar portions can be ported for execution on a hardware accelerator, thereby allowing the common portions ported for the specific hardware accelerator (e.g., an accelerated model) to be used by various different machine learning models. By reuse of the common portions, the scenario specific models may be smaller in size, thereby allowing the scenario specific models to be executed using generic hardware, such as a CPU.

As shown in architecture 200, one or more hardware accelerators 206 may be employed. The one or more hardware accelerators 206 are used to execute one or more accelerated models, such as accelerated model 1 208A and accelerated model 2 208B. As discussed above, the accelerated models may be common parts of neural networks models ported for execution on the one or more hardware accelerators 206. In one example, accelerator model 1 208A may be the common parts of a transformer-based natural language processing architecture models, while accelerator model 2 208B may be common parts of computer vision machine learning models. The featurized data is provided to the appropriate accelerator model based upon the task or type of model that will be used to perform the task (e.g., the type of scenario specific model). For example, if the featured data represents natural language input, an accelerated model associated with natural language understanding model may received the featured data. Continuing with the above example, in this instance, accelerator model 1 208A may received the featurized data. Hardware accelerator model 1 208A processes the featurized data set to generate a transformed set of featurized data. The transformed set of featurized data is then provided to one or more scenario specific models for execution on generic hardware 210. The scenario specific models process the transformed set of featurized data to perform a specific task, make a specific determination, or the like. Continuing with the above example, the transformed set of featurized natural language input may be provided by accelerated model 1 208A to one or more scenario specific models used to perform tasks based upon natural language input. For example, the transformed set of featurized data may be received by scenario specific model 1 212A to create calendar objects based upon the natural language data. Alternatively, or additionally, the transformed set of featurized data may be provided to scenario specific model 3 212C to generate a reservation (e.g., a plane ticket, hotel reservation, restaurant reservation, etc.) based upon the natural language input. As shown in the above example, a single accelerated model may be used to generate a transformed set of feature vectors for multiple different scenario specific models, thereby illustrating the reusability of the accelerated models that is made possible by the aspects of the present disclosure.

While specific examples of processing flows, data types, and tasks have been provided with respect to the discussion of architecture 200, one of skill in the art will appreciate that these are provided as examples only and do not limit the scope of this disclosure. As such, any specific discussions of processing flows, data types, tasks, or use of identified scenario specific and accelerated models are provided for purposes of illustration only and other combinations of requestor devices, scenario specific models, and/or accelerated models may be employed without departing from the scope of this disclosure.

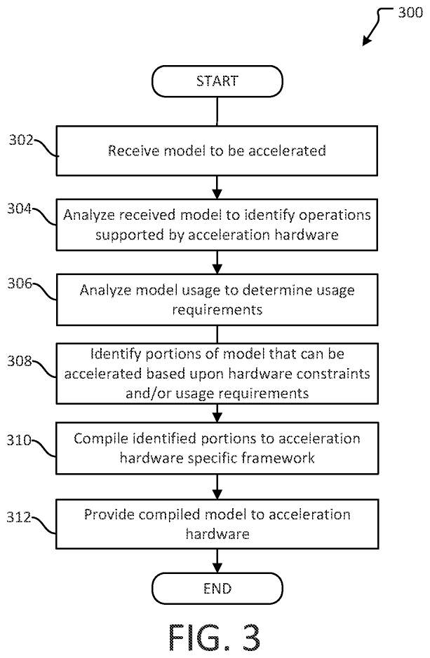

FIG. 3 depicts an exemplary method 300 for generating an accelerated model for use on a particular type of hardware accelerator. For example, a hardware accelerator may be a FPGA, a TPU, a GPU, an ASIC, or the like. As different hardware accelerators have different constraints and are able to perform different types of operations (or incapable of performing certain types of operations), an accelerated model is generated for the specific type of hardware accelerator to be used. However, as noted above, generating a specific accelerated model for every machine learning model may be computationally intensive and, therefore, resource prohibitive in certain scenarios. As such, common portions of different types of machine learning models can be generated as an accelerated model, thereby allowing one accelerated model to be reused with may different scenario specific machine learning models. Flow begins at operation 302 where a machine learning model to be accelerated (e.g., ported for use on a particular hardware accelerator) is received. As discussed above, aspects of the present disclosure can be employed regardless of the type of machine learning model used. As such, any type of machine learning model known to the art may be received at operation 302. In some examples, machine learning model may be received with a request to port the model to a specific type of hardware accelerator. Alternatively, the type of hardware accelerator may be determined based upon the available system resources (e.g., whether the system or device performing the method includes FPGA(s), GPU(s), TPU(s), etc.).

Flow continues to operation 304 where the received machine learning model is analyzed to identify the type of operations required to be performed by the different layers or nodes of the model. Upon determining they type of operations required, the identified operations are compared to the types of operations supported by the hardware accelerator that will ultimately be used to execute the accelerated model. Layers or nodes that require operations that are supported by the hardware accelerator are identified (e.g., flagged, logged, or otherwise marked) for potential conversion to the hardware accelerator.

Additionally, at operation 306, the model is analyzed to determine usage requirements. For example, a usage requirement for a model may relate to latency requirements. Certain tasks require lower latency than other tasks. For example, a model used to categorize data as a background process can tolerate high latency, while a model used for interactions with a user cannot. Based upon the model's usage requirements, portions of the model (e.g., specific layers or nodes) are identified (e.g., flagged, logged, or otherwise marked) for potential conversion to the hardware accelerator. For example, portions of the model which cannot be executed using generic hardware in accordance with the usage requirements, or alternatively, cannot be executed using the hardware accelerator due to specific limitations of the hardware accelerator, are identified.

At operation 308, portions of the model to be accelerated based upon the hardware constraints (e.g., the analysis performed at operation 304) and/or usage requirements (e.g., the analysis performed at operation 306), are identified. For example, the portions of the model that contain operations supported by the specific hardware accelerator and/or should be ported based upon the model's usage requirements, are identified at operation 308. At operation 310, the identified portions are provided to a compiler specific to the hardware accelerator. These portions of the model are compiled for execution on the hardware accelerator to generate model code capable of execution on the hardware accelerator. The compiled model code is provided to the hardware accelerator at operation 312, thereby converting portions of the model to the hardware accelerator and creating an accelerated model capable of being executed on the hardware accelerator.

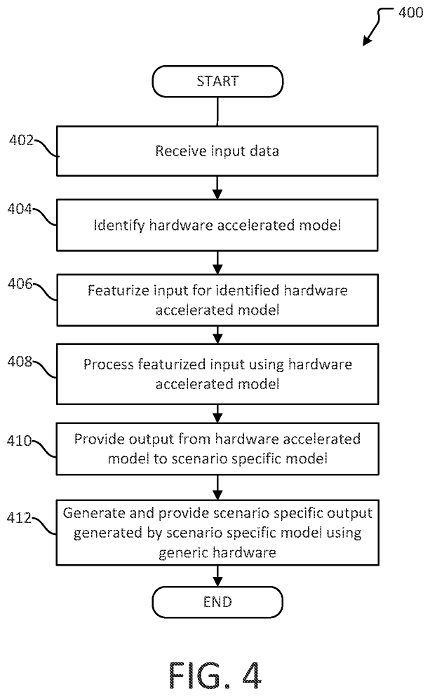

FIG. 4 depicts and exemplary method 400 for utilizing a combination of accelerator models and scenario specific models to perform a task. Flow begins at operation 402 where input data is received. The input data received is used to perform a certain task intended to be processed for a specific purpose. As such, the received input data may be associated with a scenario specific task or operation. The scenario specific tasks or operation may be indicated by a request associated with the input data (e.g., generate a reservation, categorized the input data, etc.). Alternatively, or additionally, the input data may be associated with a particular accelerated model and/or scenario specific model. In such examples, the associated request or task may be determined based upon the identified models.

At operation 404, a specific accelerated model is identified for use based upon the input data. As discussed above, the accelerated model may be identified based upon an indicator of a task or the model itself associated with the input data or a request received with the input data. Alternatively, the accelerated model may be identified based upon a type of machine learning model to be employed to perform the task. Upon identifying the accelerated model, flow continues to operation 406, where the input data is featurized for the accelerated model. In one example, featurization may include generating feature vectors in accordance with the accelerated model to be used. For example, if the input data is natural language data, operation 406 may generate tokens representing the natural language data at operation 406. The tokenization may be based upon the granularity expected by the accelerated model. That is, tokens may be generated for one or more different levels of granularity (e.g., paragraph level, multi-sentence level, sentence level, word level, multi-word level, etc.). One of skill in the art will appreciate any type of featurization may be employed at operation 406.

At operation 408, the featurized data is provided as input to the accelerated model. The accelerated model executes on hardware accelerator to generate a transformed set of data (e.g., a set of transformed feature data, a set of tensor vectors, or the like). In doing so, operation 408 processes the input data in its featurized form using an accelerated model that performs the common portions of other machine learning models (e.g., other scenario specific models). The accelerated model is optimized for execution on a specific type of hardware accelerator (e.g., FPGA, GPU, TPU, ASIC), thereby reducing latency and increasing processing efficiency for the common portion of the machine learning models.

At operation 410, the output from the accelerated model is provided to one or more scenario specific models for additional processing. In this manner, the accelerator model may act as a featurizer for the one or more scenario specific models. In one example, the scenario specific models may receive the original data or original featurized data (e.g., data generated at operation 406) in addition to the output data from the accelerator model. As discussed above, the one or more scenario specific models are machine learning models trained to perform a specific task or determination. As the common portions of the scenario specific model were performed by the accelerated model, the scenario specific model may be smaller in size, thereby reducing the computational resource requirements needed to execute the scenario specific model. As such, the scenario specific model may be executed using generic hardware, such as a CPU, while meeting usage requirements for the specific task performed by the scenario specific model. Because of this, specialized hardware is not required to efficiently execute the scenario specific model. As such, the scenario specific model may be executed on standard devices, such as client devices (e.g., laptops, tablets, PCs), smartphones, and the like. In some examples, however, the generic hardware used to execute the scenario specific model may be collocated with the accelerator hardware, thereby further reducing latency when performing the method 400. One of skill in the art, however, will appreciate that the aspects disclosed herein do not require such collocation of hardware.

At operation 412, the one or more scenario specific models are executed on generic hardware (e.g., a CPU) to generate scenario specific output. As discussed herein, any type of scenario specific output may be generated in accordance with the type and or training of the scenario specific model executed at operation 412. For example, a task may be performed, a determination may be made, data may be classified, etc. Thus, a specific task may be performed, based upon the input data received at operation 402, at operation 412.

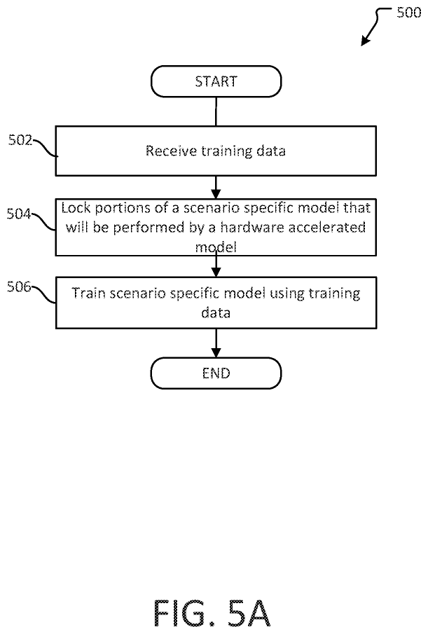

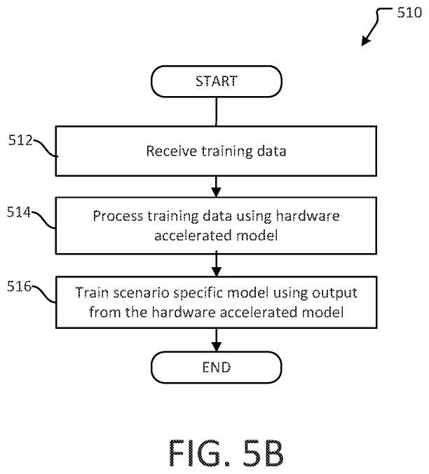

FIG. 5A depicts an exemplary method 500 for training a scenario specific model for use with the aspects disclosed herein. Flow beings at operation 502 where training data is received. The training data received at operation 502 may be any type of training data used to train machine learning models known to the art. That is, the training data may vary depending upon the task to be performed by a scenario specific model, the type of data to be analyzed by the scenario specific model, the user base associated with the scenario specific model, etc.

At operation 504, portions of the scenario specific model that correspond to an associated accelerated model are identified and locked. As described herein, the accelerated model includes portions of a machine learning model that are common (e.g., present or utilized) by various different models. These portions are identified in the scenario specific model being trained by the method 500 and lock such that the training process does not alter the common portions. Conceptually speaking, the layers or node that are included in the accelerated model are treated as a black box for the purposes of training the scenario specific model in this instance, even those portions are present in the scenario specific model when training in accordance with the method 500. At operation 506, the scenario specific model is trained using the training data. As various different types of models may be employed with the aspects disclosed herein, any type of training process known to the art may be employed at operation 408. However, unlike traditional training processes, the entire model may not be updated at operation 408. Rather, the portions of the scenario specific model that are not included in a corresponding accelerated model are adjusted during the training process.

FIG. 5B depicts yet another exemplary method 510 for raining a scenario specific model for use with the aspects disclosed herein. The method 510 differs from the method 500 in that the accelerated model is used to train the scenario specific model. In this example, a smaller scenario specific model may be trained (e.g., the trained scenario specific model does not include portions of the model that are performed by the accelerated model). Flow begins at operation 512 where training data is received. As discussed above, the training data received at operation 512 raining data received at operation 502 may be any type of training data used to train machine learning models known to the art. That is, the training data may vary depending upon the task to be performed by a scenario specific model, the type of data to be analyzed by the scenario specific model, the user base associated with the scenario specific model, etc.

At operation 514, the training data is processed using an accelerated model to generate a transformed set of featurized or vectorized data. That is, the accelerated model receives the training data, generates feature vectors of the training data, if needed, and processes the training data to generate a transformed set of featurized or vectorized data. This transformed set of featurized or vectorized data is then provided to the scenario specific model as training data. At operation 516, the scenario specific model is trained using the transformed set of featurized or vectorized data.

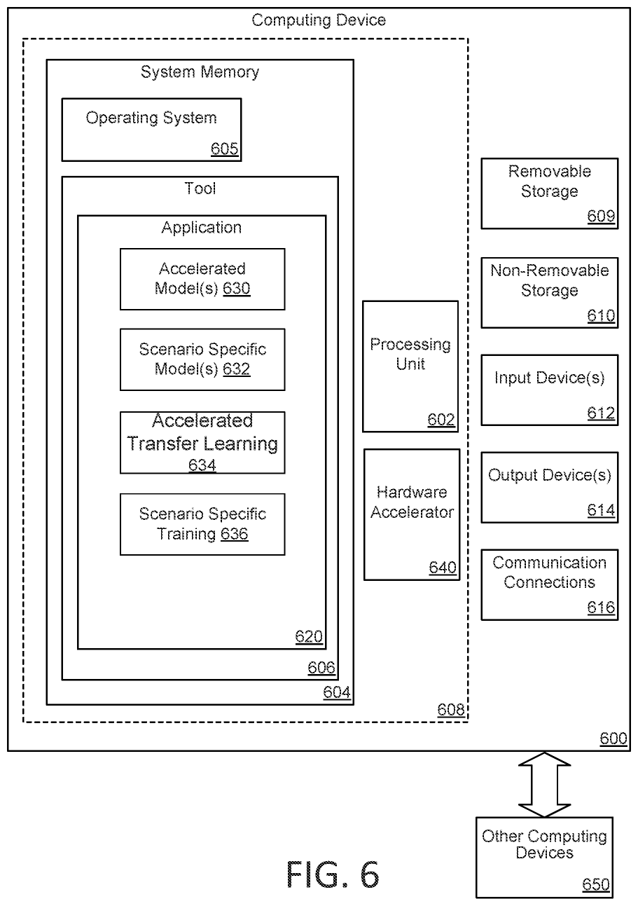

FIG. 6 is a block diagram illustrating physical components (e.g., hardware) of a computing device 600 with which aspects of the disclosure may be practiced. The computing device components described below may be suitable for the computing devices described above. In a basic configuration, the computing device 600 may include at least one processing unit 602 and a system memory 604. The computing device 600 may also include at least one hardware accelerator 640 (e.g., FPGA, GPU, TPU, ASIC) operable to execute the accelerated models disclosed herein. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program tools 606 suitable for performing the various aspects disclosed herein such. The operating system 605, for example, may be suitable for controlling the operation of the computing device 600. Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program tools and data files may be stored in the system memory 604. While executing on the at least one processing unit 602, the program tools 606 (e.g., an application 620) may perform processes including, but not limited to, the aspects, as described herein. The application 620 includes an accelerated model 630, a scenario specific model 632, process accelerated transfer learning executables 634, scenario specific training processes 636 as described in more details in FIG. 1. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 600 may also have one or more input device(s) 612, such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of the communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable, and non-removable media implemented in any method or technology for storage of information, such as computer readable instructions, data structures, or program tools. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

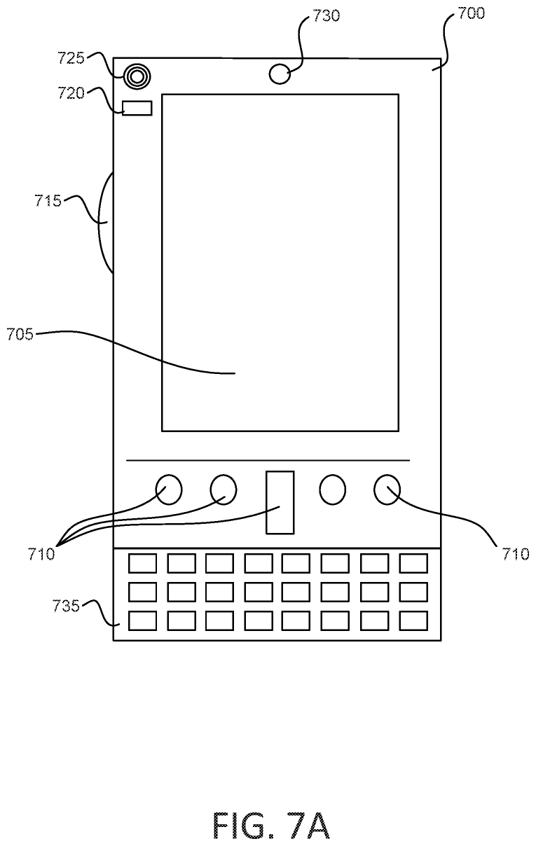

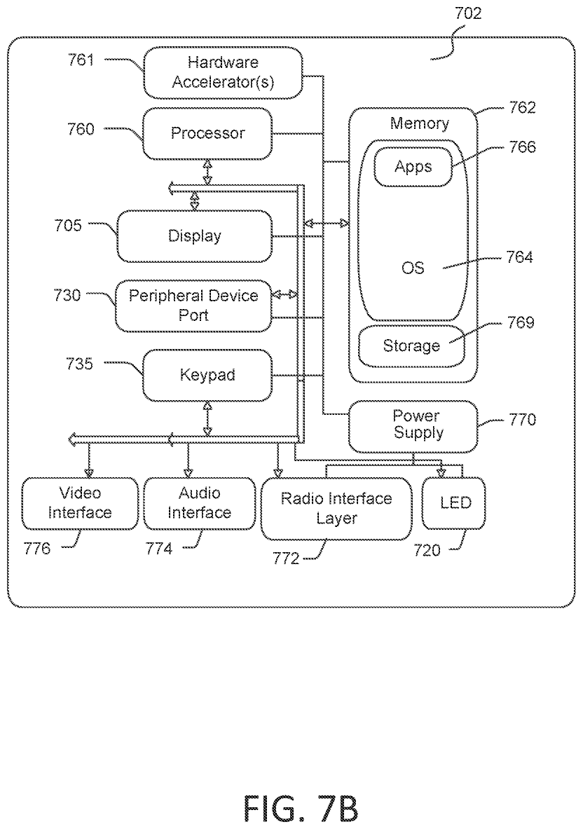

FIGS. 7A and 7B illustrate a computing device or mobile computing device 700, for example, a mobile telephone, a smart phone, wearable computer (such as a smart watch), a tablet computer, a laptop computer, and the like, with which aspects of the disclosure may be practiced. In some aspects, the client utilized by a user (e.g., the client device 102 as shown in the system 100 in FIG. 1) may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included as an optional input element, a side input element 715 allows further user input. The side input element 715 may be a rotary switch, a button, or any other type of manual input element. In alternative aspects, mobile computing device 700 may incorporate more or less input elements. For example, the display 705 may not be a touch screen in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of computing device, a server, an accelerated learning transfer service, a mobile computing device, etc. That is, computing device or the mobile computing device 700 can incorporate a system 702 (e.g., a system architecture) to implement some aspects. The system 702 can implemented as a “smart phone” capable of running one or more applications (e.g., browser, e-mail, calendaring, contact managers, messaging clients, games, and media clients/players). In some aspects, the system 702 is integrated as a computing device, such as an integrated digital assistant (PDA) and wireless phone. In still further aspects, the system 702 is a PC, a laptop, a server device, or the like.

One or more application programs 766 may be loaded into the memory 762 and run on or in association with the operating system 764, for execution by the processor 760 and/or the hardware accelerator(S) 761 (e.g., FPGA, GPU, TPU, ASIC, etc.). The system 702 also includes a non-volatile storage area 769 within the memory 762. The non-volatile storage area 769 may be used to store persistent information that should not be lost if the system 702 is powered down. The application programs 766 may use and store information in the non-volatile storage area 769, such as e-mail or other messages used by an e-mail application, and the like. A synchronization application (not shown) also resides on the system 702 and is programmed to interact with a corresponding synchronization application resident on a host computer to keep the information stored in the non-volatile storage area 769 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 (e.g., LED) may be used to provide visual notifications, and/or an audio interface 774 may be used for producing audible notifications via the audio transducer 725. In the illustrated configuration, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of devices connected to a peripheral device port 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Any of the one or more above aspects in combination with any other of the one or more aspect. Any of the one or more aspects as described herein.

What is claimed is:

1. A method for processing input data using one or more accelerated machine learning models and one or more scenario specific machine learning models, the method comprising:
receiving input data;
providing the input data to an accelerated machine learning model, wherein the accelerated machine learning model is configured to be executed on a hardware accelerator;
generating, using the accelerated machine learning model, a set of transformed feature vectors;
providing the transformed feature vectors to the one or more scenario specific machine learning models, wherein the one or more scenario specific machine learning model are configured to be executed on a central processing unit (CPU);
generating, using the one or more scenario specific models, an output determination; and
providing the output determination.

2. The method of claim 1, wherein the one or more scenario specific machine learning models are trained to perform a specific task based upon a request associated with the input data.

3. The method of claim 2, wherein providing the output determination comprises performing a task determined by the one or more scenario specific machine learning models.

4. The method of claim 1, further comprising determining, based upon the input data the accelerated machine learning model from the one or more accelerated machine learning models.

5. The method of claim 4, wherein the determination is based upon a task associated with the input data.

6. The method of claim 4, wherein the determination is based upon a type of specific machine learning model associated with the input data.

7. The method of claim 1, wherein the hardware accelerator comprises one or more of:
a field-programmable gate array (FPGA);
a graphics processing unit (GPU);
a tensor processing unit (TPU); or
an application-specific integrated circuit (ASIC).

8. The method of claim 1, wherein the accelerated machine learning model comprises common portions of a plurality of machine learning models, the common portions being executed by the plurality of machine learning models, such that the accelerated machine learning model can be used with the plurality of machine learning models.

9. The method of claim 8, wherein the accelerated machine learning models is generated based upon the common portions, wherein the common portions are compiled for execution on the hardware accelerator.

10. A system comprising:
at least one processor;
at least one field-programmable gate array (FPGA); and
memory encoding computer executable instructions that, when executed by the at least one processor, performs operations comprising:
receive input data related to a task to be processed using machine learning;
provide the input data to an accelerated machine learning model, wherein the accelerated machine learning model is configured to be executed on the FPGA;
generate, using the accelerated machine learning model, a set of transformed feature vectors;
provide the transformed feature vectors to one or more scenario specific machine learning models, wherein the one or more scenario specific machine learning model are configured to be executed on the processor;
generate, using the one or more scenario specific models, an output determination; and
provide the output determination.

11. The system of claim 10, wherein the accelerated machine learning model comprises common portions of a plurality of machine learning models, the common portions being executed by the plurality of machine learning models, such that the accelerated machine learning model can be used with the plurality of machine learning models.

12. The system of claim 11, wherein the accelerated machine learning model is generated based upon the common portions, wherein the common portions are compiled for execution on the hardware accelerator.

13. The system of claim 10, wherein the one or more scenario specific machine learning models are trained using a set of training data generated by the accelerated machine learning model.

14. The system of claim 10, wherein the one or more scenario specific machine learning models are trained using a set of training data, wherein portions of the one or more scenario specific machine learning models that correspond to the accelerated machine learning model are locked during the training process.

15. The system of claim 10, wherein the one or more scenario specific machine learning models are trained to perform a specific task based upon the input data.

16. The system of claim 15, wherein providing the output determination comprises performing a task determined by the one or more scenario specific machine learning models.

17. A computer storage medium comprising computer executable instructions that, when executed by at least one processor, performs a method comprising:
receiving input data;
providing the input data to an accelerated machine learning model, wherein the accelerated machine learning model is configured to be executed on a hardware accelerator;
generating, using the accelerated machine learning model, a set of transformed feature vectors;
providing the transformed feature vectors to one or more scenario specific machine learning models, wherein the one or more scenario specific machine learning models are configured to be executed on a central processing unit (CPU);
generating, using the one or more scenario specific models, an output determination; and
performing a task related to the input data based upon the output determination.

18. The computer storage medium of claim 17, wherein the hardware accelerator comprises one or more of:
a field-programmable gate array (FPGA);
a graphics processing unit (GPU);
a tensor processing unit (TPU); or
an application-specific integrated circuit (ASIC).

19. The computer storage medium of claim 17, wherein the accelerated machine learning model comprises common portions of a plurality of machine learning models, the common portions being executed by the plurality of machine learning models, such that the accelerated machine learning model can be used with the plurality of machine learning models.

20. The computer storage medium of claim 19, wherein the accelerated machine learning models is generated based upon the common portions, wherein the common portions are compiled for execution on the hardware accelerator.
